(19) United States
(12) Patent Application Publication
(10) Pub. No.: US 2010/0283270 A1
(43) Pub. Date: Nov. 11, 2010

(54) Magnetic Latch and Method for Manufacture Thereof

(75) Inventors: Charles D. Hood, III, Cedar Park, TX (US); Alpha Cheng, Taipei (TW); David May, Cary, IL (US); Kevin Kao, Taipei (TW); Matthew McGowan, Austin, TX (US); Timothy Radloff, Austin, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/437,117

(22) Filed: May 7, 2009

(51) Int. Cl. E05C 19/16

(52) U.S. Cl. 292/251.5

(57) ABSTRACT

A magnetic latch may include a first magnet assembly and a second magnet assembly. The first magnet assembly may have a plurality of first magnets, the first magnet assembly movable about a substantially linear axis between a first position and a second position. The second magnet assembly may have a plurality of second magnets. In the first position, the plurality of first magnets and the plurality of second magnets may be configured such that the first magnet assembly is magnetically attracted to the second magnet assembly when the first magnet assembly is substantially proximate to the second magnet assembly. In the second position, the plurality of first magnets and the plurality of second magnets may be configured such that the first magnet assembly is magnetically repelled from the second magnet assembly when the first magnet assembly is substantially proximate to the second magnet assembly.

### TECHNICAL FIELD

The present disclosure relates in general to improving the appearance of an information handling system or other item of equipment, and more particularly to a magnetic latch for an information handling system or other item of equipment.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information handling systems have become more commonplace, consumers are influenced by numerous factors in making purchases of information handling systems. While information handling system performance and capacity (e.g., processor speed, memory, non-volatile storage, peripherals, etc.) are often factors influencing consumer choices, consumers are increasingly factoring in aesthetics of information handling systems into their choices. For example, consumers often prefer information handling systems that have a more sleek or “clean” aesthetic design. To respond to such consumer demand, it is often desirable to produce information handling systems that are thin in profile. However, the design of such thin-profile information handling systems are often not structurally compatible with traditional latches that latch an information handling system in a “closed” position.

### SUMMARY

In accordance with the teachings of the present disclosure, the disadvantages and problems associated with aesthetically coupling two items of equipment have been substantially reduced or eliminated.

In accordance with one embodiment of the present disclosure, an information handling system may include a first assembly and a second assembly hingedly coupled to the first assembly. The first assembly may include a first enclosure and first magnet assembly having a plurality of first magnets, the first magnet assembly movable relative to the first enclosure between a first position and a second position. The second assembly may include a second enclosure and a second magnet assembly having a plurality of second magnets. In the first position of the first magnet assembly, the plurality of first magnets and the plurality of second magnets may be configured such that the first magnet assembly is magnetically attracted to the second magnet assembly when the first magnet assembly is substantially proximate to the second magnet assembly. in the second position of the first magnet assembly, the plurality of first magnets and the plurality of second magnets may be configured such that the first magnet assembly is magnetically repelled from the second magnet assembly when the first magnet assembly is substantially proximate to the second magnet assembly.

In accordance with another embodiment of the present disclosure, a magnetic latch may include a first magnet assembly and a second magnet assembly. The first magnet assembly may have a plurality of first magnets, the first magnet assembly movable about a substantially linear axis between a first position and a second position. The second magnet assembly may have a plurality of second magnets. In the first position of the first magnet assembly, the plurality of first magnets and the plurality of second magnets may be configured such that the first magnet assembly is magnetically attracted to the second magnet assembly when the first magnet assembly is substantially proximate to the second magnet assembly. In the second position of the first magnet assembly, the plurality of first magnets and the plurality of second magnets may be configured such that the first magnet assembly is magnetically repelled from the second magnet assembly when the first magnet assembly is substantially proximate to the second magnet assembly.

In accordance with a further embodiment of the present disclosure a system may include a first assembly and a second assembly hingedly coupled to the first assembly. The first assembly may include a first magnet assembly having a plurality of first magnets, the first magnet assembly movable between a first position and a second position. The second assembly may include a second magnet assembly having a plurality of second magnets. In the first position of the first magnet assembly, the plurality of first magnets and the plurality of second magnets are configured such that the first magnet assembly is magnetically attracted to the second magnet assembly when the first magnet assembly is substantially proximate to the second magnet assembly. In the second position of the first magnet assembly, the plurality of first magnets and the plurality of second magnets are configured such that the first magnet assembly is magnetically repelled from the second magnet assembly when the first magnet assembly is substantially proximate to the second magnet assembly.

Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an isometric view of selected components of an information handling system, in accordance with embodiments of the present disclosure;

FIG. 2A illustrates an exploded view of selected components of a movable magnet assembly for use in a magnetic latch, in accordance with embodiments of the present disclosure;

FIG. 2B illustrates an isometric view of selected components of a movable magnet assembly for use in a magnetic latch, in accordance with embodiments of the present disclosure;

FIG. 2C illustrates an isometric view of selected components of a movable magnet assembly for use in a magnetic latch, wherein such movable magnet assembly is disposed in a display assembly of an information handling system, in accordance with embodiments of the present disclosure;

FIG. 3 illustrates an exploded view of selected components of a fixed magnet assembly for use in a magnetic latch, in accordance with embodiments of the present disclosure;

FIG. 4A illustrates an isometric bottom view of selected components of a keyboard assembly of an information handling system with a bottom cover removed, in accordance with embodiments of the present disclosure;

FIG. 4B illustrates a partially-exploded view of selected components of a keyboard assembly of an information handling system, in accordance with embodiments of the present disclosure;

FIG. 5 illustrates a cross-sectional view of selected components of an information handling system, in accordance with embodiments of the present disclosure;

FIG. 6A illustrates a block diagram of a latch assembly in a first position, in accordance with embodiments of the present disclosure; and

FIG. 6B illustrates a block diagram of a latch assembly in a second position, in accordance with embodiments of the present disclosure.

### DETAILED DESCRIPTION

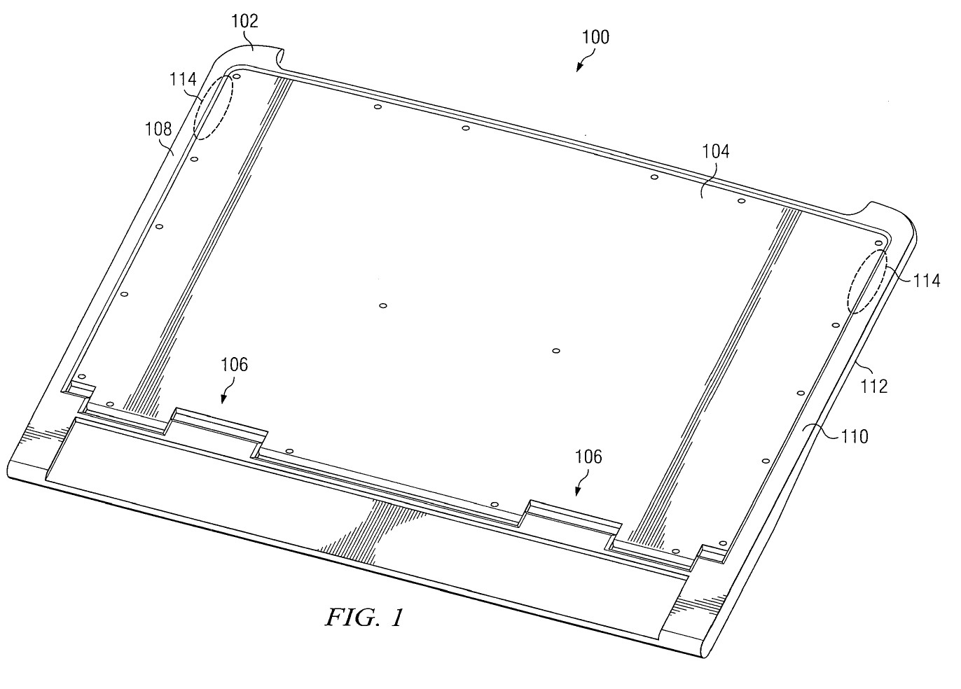

Preferred embodiments and their advantages are best understood by reference to FIGS. 1-6B, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 illustrates an isometric view of selected components of an information handling system 100 in a “closed” position, in accordance with embodiments of the present disclosure. As shown in FIG. 1, information handling system 100 is depicted as a portable computer (e.g., a “laptop” or “notebook” computer). However, in other embodiments, information handling system 100 may be a non-portable computer (e.g., a desktop computer and/or a server) or any other suitable mobile information handling system (e.g., a mobile phone, a personal digital assistant, a portable media player, etc.).

As depicted in FIG. 1, information handling system 100 may include a display assembly 102 and a keyboard assembly 104 hingedly coupled via one or more hinges 106. Each of display assembly 102 and keyboard assembly 104 may be integral parts of a chassis or case for information handling system 100. Each of display assembly 102 and keyboard assembly 104 may have an enclosure made from one or more suitable materials, including without limitation plastic and/or aluminum. Although information handling system 100 is shown in FIG. 1 as having certain components (e.g., display assembly 102, keyboard assembly 104, and hinges 106), information handling system 100 may include any other suitable components (e.g., motherboards, processors, memories, storage media, expansion cards, displays, etc.) which may not have been depicted in FIG. 1 for the purposes of clarity and exposition.

As used in this disclosure, the phrase “closed position” is used with respect to information handling system 100 to indicate a position of display assembly 102 relative to keyboard assembly 104 such that display assembly 102 substantially overlays keyboard assembly 104, or vice versa (e.g., wherein the angle formed by display assembly 102 and keyboard assembly 104 at hinges 106 is approximately zero degrees).

As used in this disclosure, the phrase “open position” is used with respect to information handling system 100 to indicate a position of display assembly 102 relative to keyboard assembly 104 such that display assembly 102 does not substantially overlay keyboard assembly 104, or vice versa (e.g., wherein the angle formed by display assembly 102 and keyboard assembly 104 at hinges 106 is substantially non zero).

In the embodiment shown in FIG. 1, the enclosure of display assembly 102 may include a bezel 108 around at a least a portion of the perimeter of display assembly 102. Bezel 108 may include a bezel cover 110 and a top cover 112 coupled to bezel cover 110. Bezel 108 may have: (i) a thickness approximately equal to the sum of the thickness of keyboard assembly 104 and the thickness of a display device disposed in display assembly 102, and/or (ii) a length and a width approximately equal to the length and width of keyboard assembly 104, such that when information handling system 100 is in a closed position, the bottom side of keyboard assembly 104 may rest substantially flush with the bottom surface of bezel 108 (e.g., a surface of bezel cover 110) and/or the thickness of information handling system 100 in the closed position is approximately equal to the thickness of display assembly 102. Such an appearance in a closed position may provide a thin profile for information handling system 100, potentially increasing its aesthetic appeal.

Typically, mechanical latches are often included on information handling systems in order to maintain the information handling system in a closed position. To open an information handling system, a user may release the latch by applying a mechanical force (e.g., to slide the latch), thus allowing the information handling system to open about its hinges. However, the design depicted in FIG. 1 may not be readily adaptable for use with mechanical latches, and the use of such latches may include visible features that may further detract from the aesthetic appeal of information handling system 100. Accordingly, one or more magnetic latches may be disposed in one or more locations 114, as described in greater detail below.

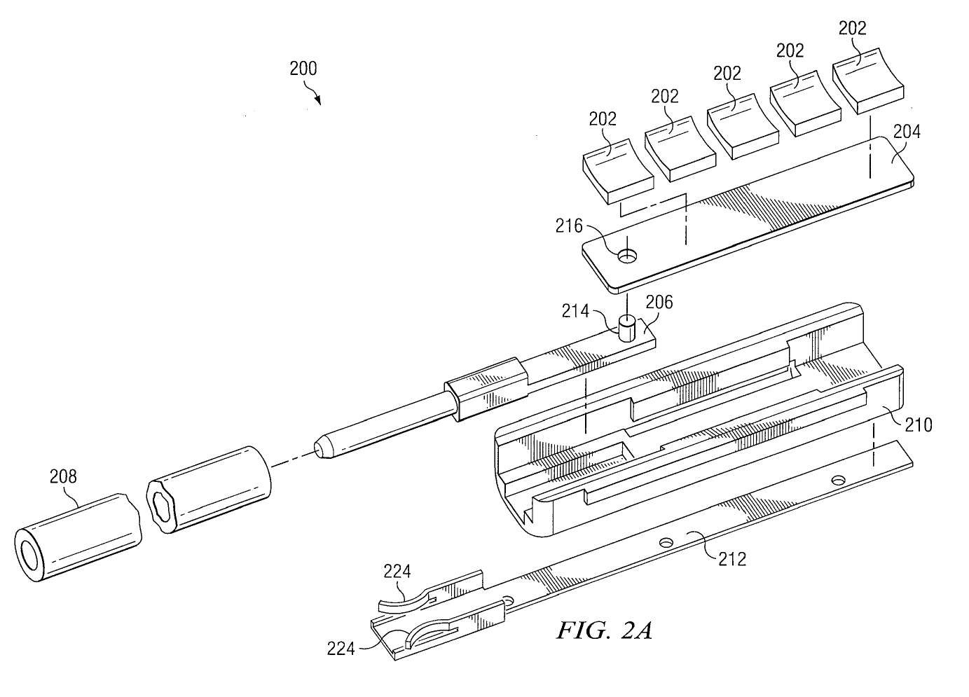

FIGS. 2A-2C illustrate various views of selected components of a movable magnet assembly 200 for use in an magnetic latch, in accordance with embodiments of the present disclosure. FIG. 2A illustrates an exploded view of movable magnet assembly 200, FIG. 2B illustrates an isometric view of movable magnet assembly 200, and FIG. 2C illustrates an isometric view of movable magnet assembly 200, wherein movable magnet assembly 200 is disposed in display assembly 102 of information handling system 100.

As depicted in FIGS. 2A-2C, movable magnet assembly 200 may include a plurality of magnets 202, a magnet plate 204, a clevis 206, an actuator 208, a carrier 210, and a contact clip 212. Each magnet 202 may include any suitable object and/or material that produces a magnetic field that may attract ferromagnetic materials (e.g., iron, nickel, cobalt), and may attract or repel other magnets.

Magnets 202 may be fixedly coupled to magnet plate 204 in any suitable manner. In some embodiments, magnet plate 204 may include a ferromagnetic material such that magnets 202 are fixedly coupled to magnet plate 204 via magnetic force. In the same or alternative embodiments, magnets 202 may be fixedly coupled to magnet plate 204 via an adhesive. As shown, each of magnets 202 may be affixed to magnet plate 204 such that at a surface of each magnet 202 opposite of magnet plate 204 exhibits a particular magnetic polarity (e.g., a magnetic field of a particular polarity perpendicular to the surface). In addition, movable magnet assembly 200 may be constructed such that the polarity of neighboring magnets is opposite. Although FIGS. 2A-2C depict magnets 202 arranged in a generally linear fashion (e.g., in a single row of magnets 202), any suitable arrangement of magnets may be used, in accordance with this disclosure (e.g., any number of suitable rows or columns).

Magnet plate 204 may be fixedly coupled to a clevis 206. Clevis 206 may be made of any suitable material and may include any structural member configured to couple magnet plate 204 to actuator 208. In the embodiment shown in FIGS. 2A-2C, magnet plate 204 may include an opening 216 configured to receive a post 214 of clevis 206, thus coupling magnet plate 204 to clevis 206.

Actuator 208 may include any system, device, or apparatus configured to induce mechanical motion of magnet plate 204 in response to actuation of actuator 208. In certain embodiments, actuator 208 may comprise a linear actuator, such that actuation of actuator 208 induces movement of magnet plate 204 along a generally linear axis (e.g., in axis 226, an axis substantially parallel to the longitudinal length of clevis 206). In one embodiment, such linear actuator may include a shape memory material (e.g., nickel-titanium or Nitinol) that changes shape (e.g., size and/or geometric shape) in response to heat and/or electric current applied to actuator 208. For example, actuator 208 may be electrically coupled to generally electrically conductive conduits 218 and 220 via which an electrical current may be delivered to actuator 208. In response to delivered electrical current, actuator 208 and/or a resistive element thereof may heat up, causing actuator 208 to expand or contract, thus inducing movement of magnet plate 204 in a generally linear axis. In addition to shape memory materials, actuator 208 may also include any other suitable linear actuator, including without limitation, a motor and screw.

Carrier 210 may include any system, device or apparatus configured to hold and/or guide movement of magnets 202 and magnet plate 204 in a generally linear axis, e.g., by including one or more features that substantially constrain movement in at least one direction other than the generally linear axis. Carrier 210 may be coupled to top cover 112 of bezel 108 via contact clip 212. Contact clip 212 may include one or more openings configured to receive fasteners (e.g., nuts, bolts, screws) fixedly coupling carrier 210 to top cover 112. As shown in FIGS. 2A-2C, contact clip may also include one or more features 224 configured to hold and/or guide movement of clevis 206 in a generally linear axis, e.g., by substantially constraining movement in at least one direction other than the generally linear axis.

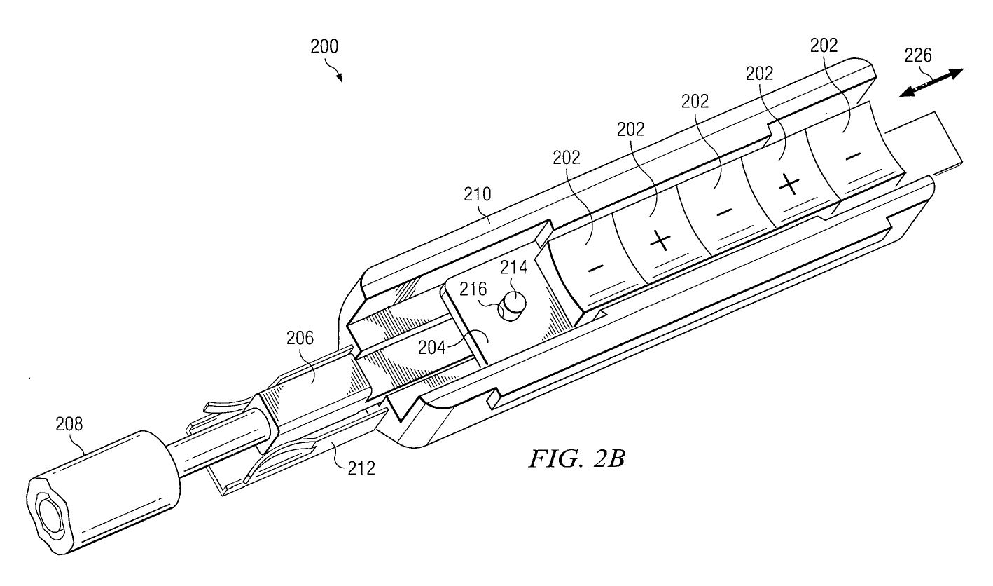

FIG. 3 illustrates an exploded view of selected components of a fixed magnet assembly 300 for use in an magnetic latch, in accordance with embodiments of the present disclosure. As depicted in FIG. 3, fixed magnet assembly 300 may include a plurality of magnets 302 and a magnet plate 304. Each magnet 302 may include any suitable object and/or material that produces a magnetic field that may attract ferromagnetic materials (e.g., iron, nickel, cobalt), and may attract or repel other magnets.

Magnets 302 may be fixedly coupled to magnet plate 304 in any suitable manner. In some embodiments, magnet plate 304 may include a ferromagnetic material such that magnets 302 are fixedly coupled to magnet plate 304 via magnetic force. In the same or alternative embodiments, magnets 302 may be fixedly coupled to magnet plate 304 via an adhesive. As shown, each of magnets 302 may be affixed to magnet plate 304 such that at a surface of each magnet 302 opposite of magnet plate 302 exhibits a particular magnetic polarity (e.g., a magnetic field perpendicular to the surface of a particular polarity). In addition, fixed magnet assembly 300 may be constructed such that the polarity of neighboring magnets is opposite. Although FIG. 3 depicts magnets 302 arranged in a generally linear fashion (e.g., in a single row of magnets 302), any suitable arrangement of magnets may be used, in accordance with this disclosure (e.g., any number of suitable rows or columns). Magnet plate 304 may include one or more openings 306 configured to couple magnet plate 304 to keyboard assembly 104, as described in greater detail below.

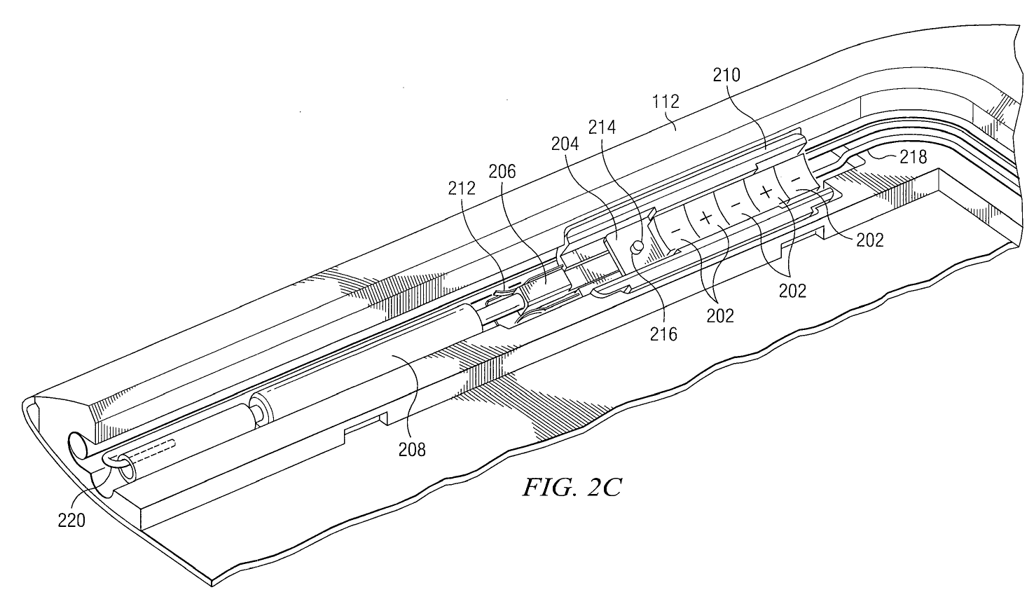

FIGS. 4A-4B illustrate various views of keyboard assembly 104, in accordance with embodiments of the present disclosure. FIG. 4A illustrates an isometric bottom view of selected components of a keyboard assembly 104 of an information handling system with a bottom cover 408 removed. FIG. 4B illustrates a partially-exploded view of selected components of keyboard assembly 104 of an information handling system.

As shown in FIGS. 4A-4B, keyboard assembly 104 may have an enclosure including a keyframe hold 402, a keyframe case 406, and a bottom cover 408. When assembled, keyframe case 406 may be coupled to bottom cover 408, with keyframe hold 402 disposed in between keyframe case 406 and bottom cover 408. Keyframe hold 402 may include one or more posts 404 configured to mate with openings 306 of magnet plate 304, in order to couple magnet plate 304 to keyboard hold 402.

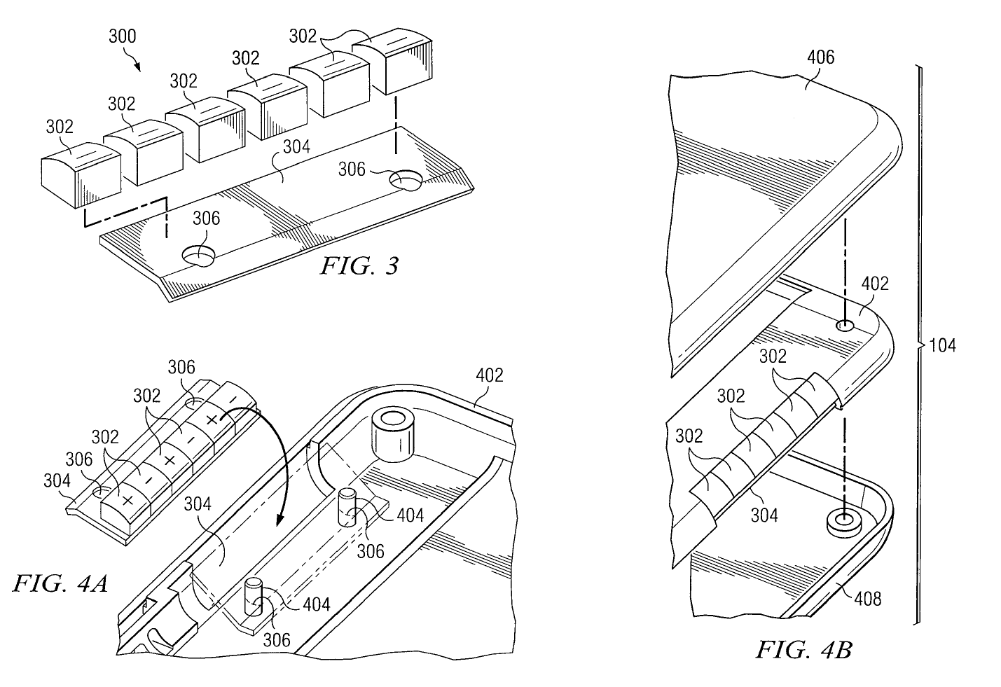

FIG. 5 illustrates a cross-sectional view approximately at a location 114 of selected components of information handling system 100 taken along the line A-A depicted in FIG. 1, in accordance with embodiments of the present disclosure. As is shown in FIG. 5, movable magnet assembly 200 may be disposed in display assembly 102 such that movable magnet assembly 200 is substantially non-visible from the exterior of information handling system 100 whether information handling system 100 is in an open or closed position. For example, movable magnet assembly 200 may be disposed in a cavity of display assembly 102 formed by bezel cover 110 and top cover 112 such that movable magnet assembly 200 is at least partially obscured from view by bezel cover 110 and top cover 112. Similarly, fixed magnet assembly 300 may be disposed in a cavity of keyboard assembly 104 formed by keyframe hold 402, keyframe case 406 and bottom cover 408 such that fixed magnet assembly 300 is at least partially obscured from view by keyframe case 406 and bottom cover 408. In addition, magnets 202 may be oriented in display assembly 102 and magnets 302 may be oriented in keyboard assembly 104 such that when information handling system 100 is in a closed position, magnets 202 are proximate to magnets 302 such that the magnetic fields of magnets 202 may interact (e.g., attract and/or repel) with magnets 302.

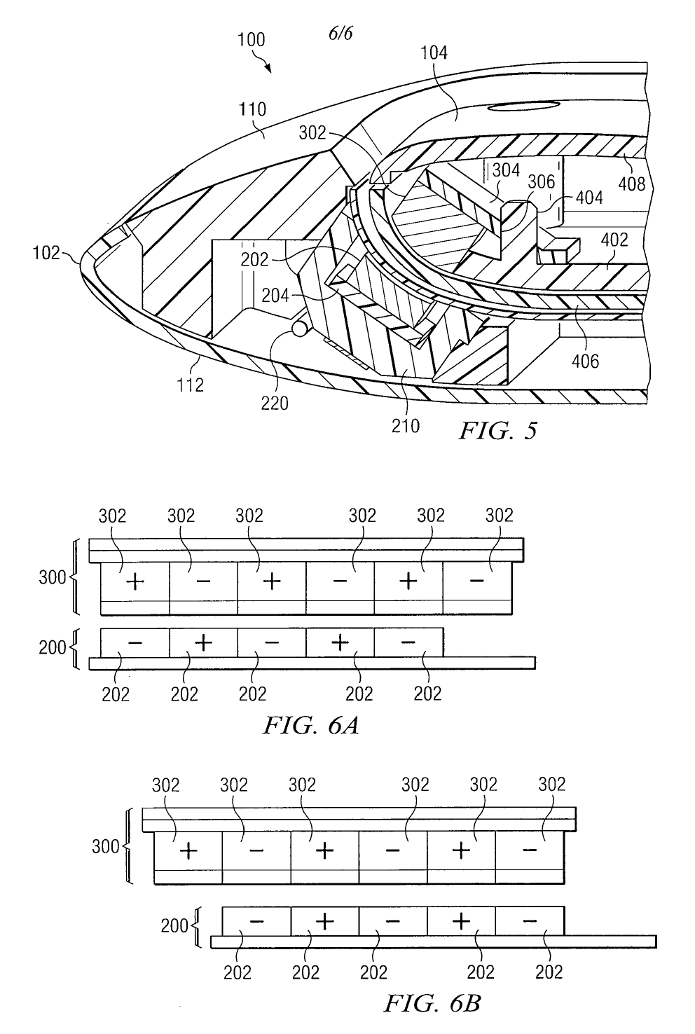

Operation of a magnetic latch comprising movable magnet assembly 200 and fixed magnet assembly 300 may be described with reference to FIGS. 6A-6B. FIG. 6A illustrates a block diagram of a magnetic latch assembly in a first position, in accordance with embodiments of the present disclosure. FIG. 6B illustrates a block diagram of an magnetic latch assembly in a second position, in accordance with embodiments of the present disclosure.

In the first position shown in FIG. 6A, magnets 202 and magnets 302 may be arranged such that movable magnet assembly 200 and fixed magnet assembly 300 are attracted to each other by magnetic force (e.g., magnets 202 of one polarity are attracted to magnets 302 of opposite polarity, and vice versa). Accordingly, in the first position, the magnetic latch may operate to bias information handling system 100 in a closed position, provided that magnets 202 and magnets 302 are close enough in proximity for their respective magnetic fields to interact.

In the second position shown in FIG. 6B, magnets 202 and magnets 302 may be arranged such that movable magnet assembly 200 and fixed magnet assembly 300 are repelled each other by magnetic force (e.g., magnets 202 of one polarity are repelled by magnets 302 of the same polarity). Accordingly, in the second position, the magnetic latch may operate to bias information handling system 100 in at least a slightly-open position, provided that magnets 202 and magnets 302 are close enough in proximity for their respective magnetic fields to interact.

Accordingly, when information handling system 100 is in a closed position, a user may open it by actuating the magnetic latch. For example, the exterior of information handling system 100 may include a button, switch, or similar device electrically coupled to actuator 208 (e.g., via conduits 218, 220). By activating (e.g., pressing) such button or switch, an electrical current may be delivered to actuator 208, which may cause actuator 208 or a resistive element thereof to increase in temperature. The increase in temperature may cause actuator 208 to change in shape (e.g., expand or contract), thus inducing movement of magnet plate 204 in a generally linear axis. Such movement of magnet plate 204 may cause magnets 202 to move from a first position in which movable magnet assembly 200 is magnetically attracted to fixed magnet assembly 300 (e.g., the first position depicted in FIG. 6A) to a second position in which movable magnet assembly 200 is magnetically repelled from fixed magnet assembly 300 (e.g., the second position depicted in FIG. 6B). The magnetic repulsion between movable magnet assembly 200 and fixed magnet assembly 300 may cause information handling system 100 to open, at least slightly, such that a user may apply force to display assembly 102 and/or keyboard assembly 104 to fully open information handling system 100.

After a user has finished activating the button or switch, electrical current delivered to actuator 208 may cease, such that actuator 208 or a resistive element thereof decreases in temperature. Such decrease in temperature may return actuator 208 to its original shape, thus inducing movement of magnet plate 204 to its original position. Accordingly, when a user later closes information handling system 100 returning it to its closed position, magnets 200 may be aligned with magnets 300 such that movable magnet assembly 200 is magnetically attracted to fixed magnet assembly 300, thus biasing information handling system 100 in the closed position.

Although the present disclosure describes an embodiment whereby movable magnet assembly 200 is an integral part of display assembly 102 and fixed magnet assembly 300 is an integral part of keyboard assembly 104, certain embodiments of information handling system 100 may include display assembly 102 having fixed magnet assembly 300 or a similar fixed magnet assembly and may further include keyboard assembly 104 having movable magnet assembly 200 or a similar movable magnet assembly.

In addition, although the present disclosure describes use of a magnetic latch for use in an information handling system, systems and methods similar to those set forth in this disclosure may be utilized to provide a latch for any other suitable item of equipment.

Using the methods and systems disclosed herein, problems associated with traditional mechanical latches may be reduced or eliminated. For example, methods and systems disclosed herein may provide a technique for providing a latch in a thin-profile information handling system or other piece of equipment such that the latch is aesthetically hidden from the view of the user.

Although the present disclosure has been described in detail, it should be understood that various changes, substitutions, and alterations can be made hereto without departing from the spirit and the scope of the disclosure as defined by the appended claims.

1. An information handling system, comprising:
a first assembly including a first enclosure and first magnet assembly having a plurality of first magnets, the first magnet assembly movable relative to the first enclosure between a first position and a second position; and
a second assembly hingedly coupled to the first assembly and including a second enclosure and a second magnet assembly having a plurality of second magnets;
wherein:
in the first position of the first magnet assembly, the plurality of first magnets and the plurality of second magnets are configured such that the first magnet assembly is magnetically attracted to the second magnet assembly when the first magnet assembly is substantially proximate to the second magnet assembly; and
in the second position of the first magnet assembly, the plurality of first magnets and the plurality of second magnets are configured such that the first magnet assembly is magnetically repelled from the second magnet assembly when the first magnet assembly is substantially proximate to the second magnet assembly.

2. An information handling system according to claim 1, wherein the second magnet assembly is fixed relative to the second enclosure.

3. An information handling system according to claim 1, wherein:
the plurality of first magnets are configured in a first row with alternating first and second magnetic polarities;
the plurality of first magnets are configured in a second row with alternating first and second magnetic polarities;
in the first position of the first magnet assembly, each of the plurality of first magnets of the first magnetic polarity are attracted to a corresponding one of the plurality of second magnets of the second magnetic polarity and each of the plurality of first magnets of the second magnetic polarity are attracted to a corresponding one of the plurality of second magnets of the first magnetic polarity, such that the first magnet assembly is magnetically attracted to the second magnet assembly when the first magnet assembly is substantially proximate to the second magnet assembly; and
in the second position of the first magnet assembly, each of the plurality of first magnets of the first magnetic polarity are repelled by a corresponding one of the plurality of second magnets of the first magnetic polarity and each of the plurality of first magnets of the second magnetic polarity are repelled by a corresponding one of the plurality of second magnets of the second magnetic polarity, such that the first magnet assembly is magnetically repelled from the second magnet assembly when the first magnet assembly is substantially proximate to the second magnet assembly.

4. An information handling system according to claim 1, the first magnet assembly further including a linear actuator mechanically coupled to the plurality of first magnets, the linear actuator configured to induce movement of the plurality of first magnets in a substantially linear axis.

5. An information handling system according to claim 4, the linear actuator comprising a shape memory material mechanically coupled to the plurality of first magnets and operable to change shape in response to at least one of heat and electrical current applied to the shape memory material, wherein such change in shape induces movement of the plurality of first magnets in a substantially linear axis.

6. An information handling system according to claim 5, the shape memory material comprising a nickel-titanium alloy.

7. An information handling system according to claim 1, the first assembly comprising a display assembly and the second assembly comprising a keyboard assembly.

8. An information handling system according to claim 1, the first assembly comprising a keyboard assembly and the second assembly comprising a display assembly.

9. An information handling system according to claim 1, the first magnet assembly substantially covered by the first enclosure such that the first magnet assembly is substantially non-visible from the exterior of the information handling system.

10. An information handling system according to claim 1, the second magnet assembly substantially covered by the second enclosure such that the second magnet assembly is substantially non-visible from the exterior of the information handling system.

11. An information handling system according to claim 1, the first assembly including a bezel such that when information handling system is in a closed position, a bottom surface of the second assembly may rest substantially flush with a bottom surface of the bezel.

12. An information handling system according to claim 11, wherein the first magnet assembly is disposed in a cavity formed by the bezel.

13.-21. (canceled)
